(19) United States
(12) Patent Application Publication
(10) Pub. No.: US 2024/0359855 A1
(43) Pub. Date: Oct. 31, 2024

(54) MANUFACTURING METHOD OF LABELED ARTICLE, LABEL BULK ROLL, AND LABEL

(71) Applicant: FUJI SEAL INTERNATIONAL, INC., Osaka-shi, Osaka (JP)

(72) Inventors: Yukitoshi ETANI, Osaka-shi (JP); Yoshikazu KAKURA, Osaka-shi (JP)

(21) Appl. No.: 18/682,591

(22) PCT Filed: Aug. 9, 2022
(86) PCT No.: PCT/JP2022/030404

§ 371 Date: Feb. 9, 2024

(30) Foreign Application Priority Data
Aug. 11, 2021 (JP) 2021-131106

(51) Int. Cl. B65C 9/00; B65C 9/18; G09F 3/02; G09F 3/10

(52) U.S. Cl. CPC B65C 9/0015; B65C 9/1807; G09F 3/02; G09F 3/10; B65C 2009/0031; G09F 2003/025; G09F 2003/0258

(57) ABSTRACT

A manufacturing method of a labeled article includes a preparing step of preparing a label bulk roll formed by winding up a continuous label body being linerless into a roll shape, a feeding step of feeding the continuous label body from the label bulk roll, a cutting step of cutting the continuous label body into individual units of labels, an activating step of activating an adhesive layer of the label, a conveying step of conveying an activated label that is the label including the adhesive layer in an activated state from an activation position where the adhesive layer is activated to a separated position separated from the activation position, and an affixing step of affixing the activated label to an article at the separated position.

### TECHNICAL FIELD

The present invention relates to a manufacturing method of a labeled article, a label bulk roll, and a label.

### BACKGROUND ART

Conventionally, there is known a method of affixing a so-called linerless label including no release paper to an article. For example, JP 2010-36980 A discloses a method of affixing a label to a container, the method including delivering a label from a label delivery drum to an adsorption drum at a delivery position, rotating the adsorption drum while heating the adsorption drum by using a heating device, and subsequently conveying the label from the delivery position of the label to an affixing position while activating a heat-sensitive adhesive (applied to a surface not in contact with an adsorption surface of the adsorption drum) of the label, and affixing the label in a state where the heat-sensitive adhesive is activated to a container at the affixing position.

### CITATION LIST

### Patent Literature

Patent Literature 1: JP 2010-36980 A

### SUMMARY OF INVENTION

### Technical Problem

In the method of affixing the label as described in JP 2010-36980 A, both heating the label for activating the adhesive layer and affixing the label to the container are performed by using the adsorption drum. Thus, it is desirable that the adsorption drum controls both an amount of heating and pressure when affixing the label to the container. As a result, it is difficult to improve utility.

An object of the present invention is to provide a manufacturing method of a labeled article, a label bulk roll, and a label, which can improve utility.

### Solution to Problem

According to one aspect of the present invention, there is provided a manufacturing method of a labeled article, the manufacturing method including a preparing step of preparing a label bulk roll formed by winding up a continuous label body being linerless into a roll shape, the continuous label body including a base material sheet having a shape extending in one direction and an adhesive layer provided on a back surface of the base material sheet, a feeding step of feeding the continuous label body from the label bulk roll, a cutting step of cutting the continuous label body into individual units of labels, an activating step of activating the adhesive layer of the label, a conveying step of conveying an activated label that is the label including the adhesive layer in an activated state from an activation position where the adhesive layer is activated to a separated position separated from the activation position, and an affixing step of affixing the activated label to an article at the separated position.

According to one aspect of the present invention, there is provided a label bulk roll formed by winding up a continuous label body being linerless into a roll shape, the continuous label body including a base material sheet having a shape extending in one direction and an adhesive layer provided on a back surface of the base material sheet, in which an affixing force of the adhesive layer is equal to or less than ball No. 4 in a special ball tack test before activation of the adhesive layer, is equal to or more than ball No. 6 in the special ball tack test immediately after the activation of the adhesive layer, and is equal to or more than ball No. 5 in the special ball tack test 5 seconds after the activation of the adhesive layer.

The special ball tack test is a test similar to a normal inclined ball tack test. The special ball tack test corresponds to an inclined ball tack test in which the approach section is omitted. That is, in the special ball tack test, a ball rolling device that is used in the inclined ball tack test is used. The ball rolling device includes an inclined surface having an inclination angle of 30°. A sample having dimensions equal to or larger than a width of 10 mm and a length of 70 mm is placed on the inclined surface. Specifically, a front surface of the sample is constituted by an adhesive layer, and the sample is placed on the inclined surface such that the adhesive layer faces upward. In this special ball tack test, a ball is placed on an upper end portion of the sample so as not to apply a pressure to the adhesive layer, unlike in the normal inclined ball tack test. Then, the ball number of the largest ball that rolled down and stopped due to its own weight on the adhesive layer is taken as a measurement value.

According to one aspect of the present invention, there is provided a label including a lower base material, an adhesive layer provided on a back surface of the lower base material, and an upper base material provided on a front surface of the lower base material, the upper base material having an outer shape smaller than an outer shape of the lower base material, in which an affixing force of the adhesive layer is equal to or less than ball No. 4 in a special ball tack test before activation of the adhesive layer, is equal to or more than ball No. 6 in the special ball tack test immediately after the activation of the adhesive layer, and is equal to or more than ball No. 5 in the special ball tack test 5 seconds after the activation of the adhesive layer.

### Advantageous Effects of Invention

According to the present invention, it is possible to provide a manufacturing method of a labeled article, a label bulk roll, and a label, which can improve utility.

### BRIEF DESCRIPTION OF DRAWINGS

FIG. 1 is a front view schematically illustrating a labeled article according to an embodiment of the present invention.

FIG. 2 is a perspective view of a label bulk roll and a continuous label body.

FIG. 3 is a cross-sectional view taken along line III-III in FIG. 2.

FIG. 4 is a diagram schematically illustrating a test method of a special ball tack test.

FIG. 5 is a diagram schematically illustrating a manufacturing process of a labeled article.

FIG. 6 is an enlarged view of a range indicated by a solid line VI in FIG. 5.

FIG. 7 is a diagram schematically illustrating a manufacturing process of a label bulk roll.

FIG. 8 is an enlarged view of a range indicated by a solid line VIII in FIG. 7.

FIG. 9 is an enlarged view of a range indicated by a solid line IX in FIG. 7.

FIG. 10 is an enlarged view of a range indicated by a solid line X in FIG. 7.

FIG. 11 is an enlarged view of a range indicated by a solid line XI in FIG. 7.

FIG. 12 is an enlarged view of a range indicated by a solid line XII in FIG. 7.

FIG. 13 is an enlarged view of a range indicated by a solid line XIII in FIG. 7.

FIG. 14 is an enlarged view of a range indicated by a solid line XIV in FIG. 7.

FIG. 15 is a cross-sectional view schematically illustrating a cross section of a label bulk roll.

FIG. 16 is a cross-sectional view schematically illustrating a modification of a bonding layer forming step.

FIG. 17 is a cross-sectional view schematically illustrating a modification of a cutting step.

FIG. 18 is a cross-sectional view schematically illustrating a modification of a label.

FIG. 19 is a cross-sectional view schematically illustrating a modification of the label.

FIG. 20 is a cross-sectional view schematically illustrating a modification of the label.

FIG. 21 is a cross-sectional view schematically illustrating a modification of the label.

FIG. 22 is a cross-sectional view schematically illustrating a modification of the label.

FIG. 23 is a cross-sectional view schematically illustrating a modification of the label.

FIG. 24 is a table showing configurations and evaluation results of Examples and Comparative Examples.

### DESCRIPTION OF EMBODIMENTS

Embodiments of the invention will be described with reference to the drawings. Note that in the drawings, which will be referred to below, the same reference signs are assigned to the same or corresponding members.

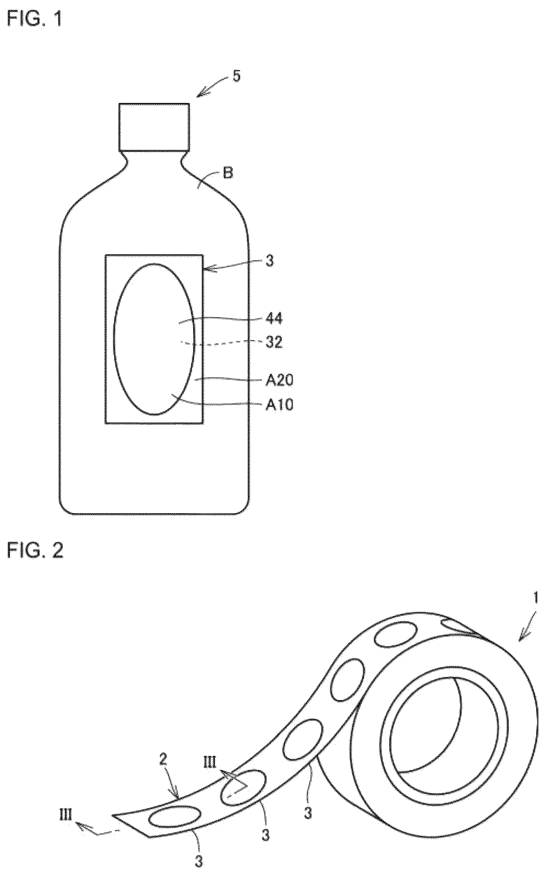

FIG. 1 is a diagram schematically illustrating a labeled article according to an embodiment of the present invention. As illustrated in FIG. 1, a labeled article 5 includes an article B and a label 3. In FIG. 1, a container that can contain liquid or the like is illustrated as the article B. However, the article B is not limited to the container. The article B may have optical transparency.

The label 3 is affixed to a front surface of the article B. FIG. 2 illustrates a continuous label body 2 including a plurality of labels 3. The continuous label body 2 includes the plurality of labels 3 disposed so as to be aligned in one direction. The continuous label body 2 is a so-called linerless continuous label body including no release paper (liner). A label bulk roll 1 is formed by winding up the continuous label body 2 into a roll shape. The linerless label is an environmentally friendly label aligned with SDGs because release paper is not generated as a waste product when affixing the linerless label to the article B.

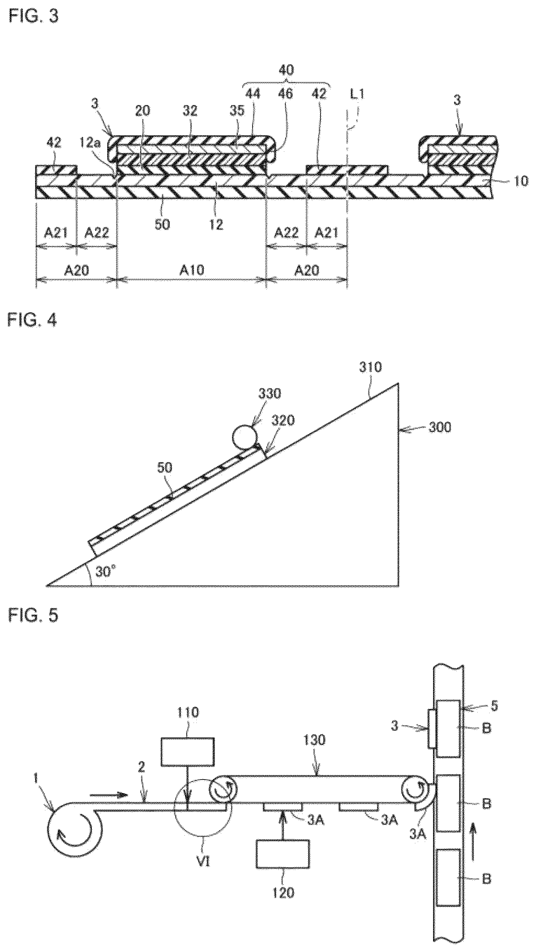

As illustrated in FIG. 3, the label 3 includes a lower base material 12, a bonding layer 20, an upper base material 32, a print layer 35, an overcoat layer 40, and an adhesive layer 50.

The lower base material 12 is made of synthetic resin, such as polyethylene terephthalate or polypropylene. The lower base material 12 is made of a material having optical transparency. Herein, “having optical transparency” refers to having a haze value of less than 20%. The haze value of the lower base material 12 is preferably less than 10%, and more preferably less than 7%. A thickness of the lower base material 12 is about from 9 μm to 50 μm.

The upper base material 32 is provided on a front surface of the lower base material 12 via the bonding layer 20. An adhesive strength of the bonding layer 20 is preferably equal to or more than 3 N/25 mm, and more preferably equal to or more than 5 N/25 mm. The upper base material 32 has an outer shape smaller than an outer shape of the lower base material 12. The upper base material 32 may have an optical transparency lower than the optical transparency of the lower base material 12, or may have an optical transparency substantially equal to the optical transparency of the lower base material 12. The upper base material 32 is made of synthetic resin, paper, or the like. A thickness of the upper base material 32 is preferably about from 30 μm to 100 μm.

As illustrated in FIG. 3, a recessed portion 12a corresponding to the outer shape of the upper base material 32 is formed in a front surface of the lower base material 12. The recessed portion 12a has a shape recessed from the front surface toward a back surface of the lower base material 12. The recessed portion 12a is formed at a position coinciding with an outer edge portion of the upper base material 32 in a plan view of the label 3.

The print layer 35 is provided on a front surface of the upper base material 32. The print layer 35 is a layer that displays a design or the like. The print layer 35 may be omitted.

The overcoat layer 40 is provided on the front surface of the lower base material 12 and the front surface of the upper base material 32. The overcoat layer 40 protects the front surface of the lower base material 12 and the front surface of the upper base material 32. The overcoat layer 40 contains a material having peelability. For example, the overcoat layer 40 is made of a material in which silicone-based resin or fluorine-based resin is added to acrylic acid ester-based resin. The overcoat layer 40 has optical transparency.

As illustrated in FIG. 3, the overcoat layer 40 includes a lower base material covering portion 42, an upper base material covering portion 44, and a side surface covering portion 46.

The lower base material covering portion 42 covers a front surface of a portion of the lower base material 12 surrounding the upper base material 32. A gap is formed between the lower base material covering portion 42 and the upper base material 32.

The upper base material covering portion 44 covers the front surface of the upper base material 32. Here, the “front surface of the upper base material 32” refers to the front surface of the print layer 35 when the print layer 35 is provided on the front surface of the upper base material 32, and refers to the front surface of the upper base material 32 when the print layer 35 is omitted.

The side surface covering portion 46 covers a side surface of the upper base material 32.

The side surface covering portion 46 is connected to the upper base material covering portion 44. A lower end portion of the side surface covering portion 46 may be in contact with the front surface of the lower base material 12 or may be separated from the front surface of the lower base material 12. The gap is formed between the side surface covering portion 46 and the lower base material covering portion 42. However, as long as the gap is formed between the upper base material 32 and the lower base material covering portion 42, the lower end portion of the side surface covering portion 46 may be connected to the lower base material covering portion 42.

The adhesive layer 50 is provided on the back surface of the lower base material 12. The adhesive layer 50 is a layer that is brought into contact with the front surface of the article B. The adhesive layer 50 is made of a material having optical transparency. The adhesive layer 50 may be made of a material having adhesiveness. A thickness of the adhesive layer 50 is about 20 μm.

The adhesive layer 50 is made of a material that is activated by light energy such as ultraviolet light or infrared light, or a material that is activated by thermal energy such as hot air. In the present embodiment, the adhesive layer 50 is made of a material containing ultraviolet curable resin, that is, a material that is activated by light energy. The main component of the material constituting the adhesive layer 50 is not particularly limited, and examples thereof include olefin rubber, styrene-based resin, and a tackifier. To the main component, a plasticizer, olefin wax, amide-based resin, cellulose resin, or the like may be added as an additive.

The affixing force of the adhesive layer 50 is equal to or less than ball No. 4 in a special ball tack test before activation of the adhesive layer 50, is equal to or more than ball No. 6 in the special ball tack test immediately after activation of the adhesive layer 50, and is equal to or more than ball No. 5 in the special ball tack test 5 seconds after the activation of the adhesive layer 50. The affixing force of the adhesive layer 50 is preferably equal to or more than ball No. 4 in the special ball tack test 15 seconds after the activation of the adhesive layer 50. Note that the affixing force refers to a force (physical property value) when the adhesive layer 50 is affixed to the article B, and is different from “adhesive force” which refers to force that is required to peel off the adhesive layer 50 from the article B after the adhesive layer 50 is affixed to the article B.

The special ball tack test is a test similar to a normal inclined ball tack test. The special ball tack test corresponds to an inclined ball tack test in which the approach section is omitted. That is, in the special ball tack test, a ball rolling device 300 used in the inclined ball tack test is used. The ball rolling device 300 includes an inclined surface 310 with an inclination angle of 30°. A sample 320 having dimensions equal to or larger than a width of 10 mm and a length of 70 mm is placed on the inclined surface 310, as illustrated in FIG. 4. More specifically, a front surface of the sample 320 is constituted by the adhesive layer 50 and the sample 320 is placed on the inclined surface 310 such that the adhesive layer 50 faces upward. In this special ball tack test, a ball 330 is placed at an upper end portion of the sample 320 so as not to apply pressure to the adhesive layer 50, unlike in the normal inclined ball tack test. Then, the ball number of the largest ball that rolled down and stopped due to its own weight on the adhesive layer 50 is taken as a measurement value.

As illustrated in FIG. 3, the label 3 includes an overlapping region A10 and a non-overlapping region A20.

The overlapping region A10 is a region overlapping the upper base material 32 in a layered direction (the vertical direction in FIG. 3) of the lower base material 12 and the upper base material 32. The non-overlapping region A20 is a region that does not overlap the upper base material 32 in the layered direction. In other words, the non-overlapping region A20 is a region surrounding the upper base material 32 in a plan view of the label 3.

A haze value in the overlapping region A10 is larger than a haze value in the non-overlapping region A20. The haze value in the non-overlapping region A20 is preferably less than 15.0, and more preferably less than 10.0.

The non-overlapping region A20 includes an outer region A21 and an inner region A22. The outer region A21 is a region overlapping the lower base material covering portion 42 in the layered direction. The inner region A22 is a region not overlapping the lower base material covering portion 42 in the layered direction. The inner region A22 is formed inside the outer region A21 around the overlapping region A10 in a plan view of the label 3. A haze value in the inner region A22 is smaller than a haze value in the outer region A21.

Next, a manufacturing method of the labeled article 5 will be described with reference to FIG. 5. The manufacturing method of the labeled article 5 includes a preparing step, a feeding step, a cutting step, an activating step, a conveying step, and an affixing step.

The preparing step is a step of preparing the label bulk roll 1 in which the continuous label body 2 is wound up into a roll shape.

The feeding step is a step of feeding the continuous label body 2 from the label bulk roll 1. A blocking value at the time of feeding the continuous label body 2 from the label bulk roll 1 is preferably equal to or less than 1.0 N/15 mm, and more preferably equal to or less than 0.7 N/15 mm.

The blocking value is measured as follows. First, a second test piece (width: 15 mm) is overlaid on a first test piece (width: 15 mm) such that the adhesive layer 50 in the second test piece of the label 3 is brought into contact with a front surface of the overcoat layer 40 in the first test piece of the label 3. Subsequently, in a heat sealing tester, pressure is applied to the first test piece and the second test piece at 80° C. and 0.5 MPa for 10 seconds, and then a T-type peeling strength between the first test piece and the second test piece is measured. A tensile strength (bonding strength) at this time corresponds to the blocking value.

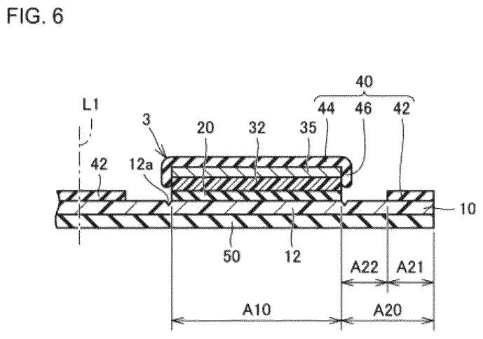

The cutting step is a step of cutting the fed continuous label body 2 to the size of each label 3 including a single upper base material 32. As illustrated in FIG. 5, in this step, the continuous label body 2 is cut by a cutting unit 110. As illustrated in FIG. 6, the cutting unit 110 cuts the continuous label body 2 along a predetermined cutting line L1 positioned in the lower base material covering portion 42 provided between a pair of the upper base materials 32 adjacent to each other. Note that the continuous label body 2 may or may not be provided with an indication or the like indicating the predetermined cutting line L1.

The activating step is a step of activating the adhesive layer 50 of the label 3. As illustrated in FIG. 5, in this step, an energy radiation unit 120 radiates light energy (e.g., ultraviolet light) that activates the adhesive layer 50 toward the adhesive layer 50. At this time, for example, the energy radiation unit 120 radiates light energy such that an accumulated amount of light is equal to or larger than 150 mJ/cm². As a result, the adhesive layer 50 of the label 3 is activated. The label 3 may include an energy absorber that absorbs light energy. The energy absorber is preferably added to the adhesive layer 50, the overcoat layer 40, or the bonding layer 20. In the present embodiment, an ultraviolet absorber is added as the energy absorber to at least one of the adhesive layer 50, the overcoat layer 40, and the bonding layer 20, and the energy radiation unit 120 radiates ultraviolet light. In a case in which the energy absorber is added to the adhesive layer 50, an addition amount thereof is preferably from 0.5% to 10%, and more preferably from 1% to 5%. In a case in which the energy absorber is added to the overcoat layer 40 or the bonding layer 20, an addition amount thereof is preferably from 5% to 30%, and more preferably from 10% to 20%. Note that, in a case in which the adhesive layer 50 is made of a material that is activated by thermal energy, the energy radiation unit 120 applies thermal energy such as hot air to the adhesive layer 50.

The conveying step is a step of conveying an activated label 3A, which is the label 3 including the adhesive layer 50 in an activated state. As illustrated in FIG. 5, in this step, a conveyor 130 conveys the activated label 3A. A conveying speed of the conveyor 130 can be adjusted to a freely selected speed between a relatively low first speed at the time of startup or the like and a relatively high second speed at the time of mass production or the like. A region of the conveyor 130 downstream of the energy radiation unit 120 is not irradiated with the light energy. That is, in the conveying step, the activated label 3A is conveyed in a state where the adhesive layer 50 is not activated, from an activation position where the adhesive layer 50 is activated (a position irradiated by the light energy from the energy radiation unit 120) to a separated position separated from the activation position. In other words, in the conveying step, the activated label 3A is conveyed from the activation position to the separated position while reducing the affixing force of the adhesive layer 50.

The affixing step is a step of affixing the activated label 3A to the article B at the separated position separated from the energy radiation unit 120. The article B is conveyed by a conveyor or the like. The affixing step may be performed within, for example, 15 seconds after the activating step, that is, when the affixing force of the adhesive layer 50 is equal to or more than ball No. 4 in the special ball tack test when the conveying speed of the conveyor 130 is the first speed, and may be performed within, for example, 5 seconds after the activating step, that is, when the affixing force of the adhesive layer 50 is equal to or more than ball No. 5 in the special ball tack test when the conveying speed of the conveyor 130 is the second speed.

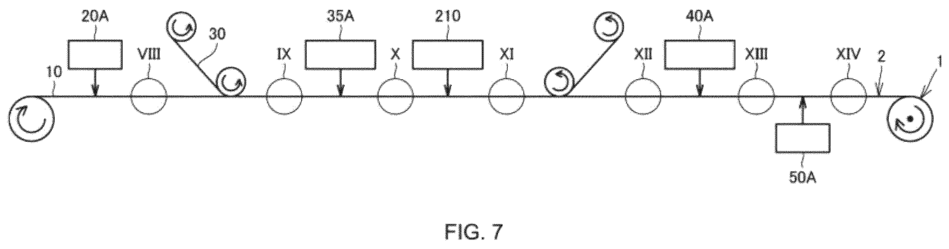

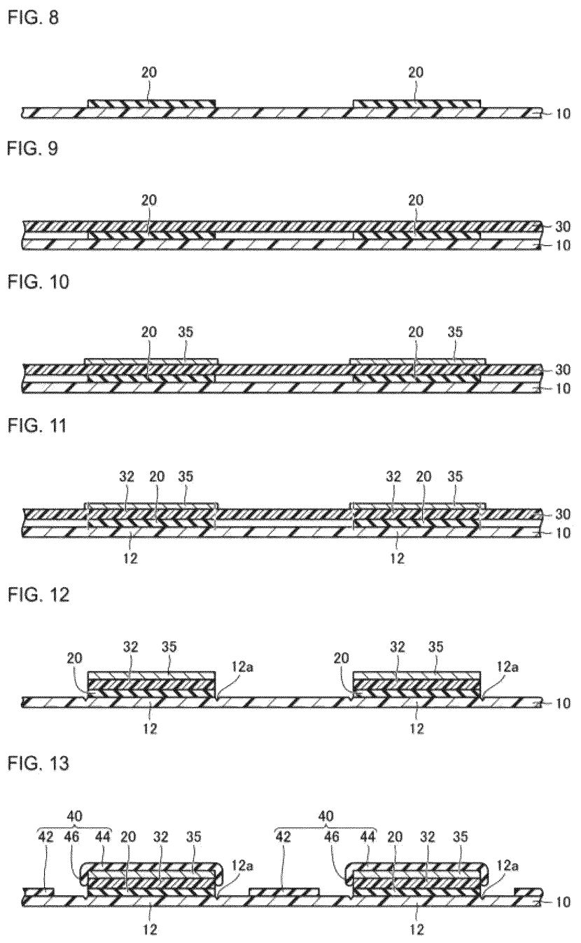

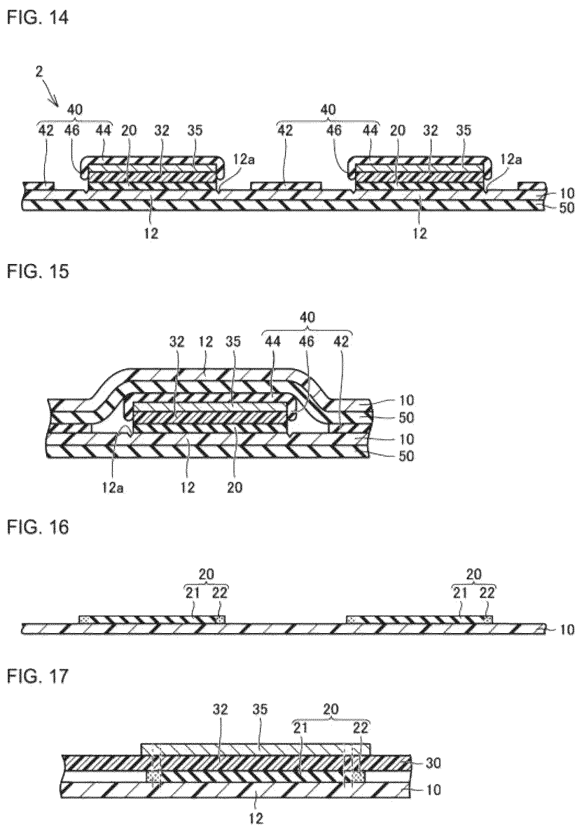

Next, a manufacturing method of the label bulk roll 1 will be described with reference to FIG. 7 to FIG. 15. The manufacturing method of the label bulk roll 1 includes a layering step, a printing step, a cutting step, a removing step, a coating step, and an adhesive layer forming step.

The layering step is a step of layering an upper base material sheet 30 on a front surface of a base material sheet (hereinafter, referred to as a “lower base material sheet 10”) via the bonding layer 20. The lower base material sheet 10 is a sheet including a plurality of the lower base materials 12 and has a shape extending in one direction. A portion of the lower base material sheet 10 between a pair of predetermined cutting lines L1 constitutes the lower base material 12. The upper base material sheet 30 is a sheet including a plurality of the upper base materials 32 disposed so as to be aligned at intervals in one direction, and has a shape extending in the one direction. Note that the upper base material sheet 30 may be omitted, and in this case, the layering step is omitted.

As illustrated in FIG. 7 to FIG. 9, the layering step includes a bonding layer forming step of supplying a bonding material from a bonding material supplying unit 20A to the front surface of the lower base material sheet 10 and subsequently forming the bonding layer 20 on the lower base material sheet 10, and a placing step of placing the upper base material sheet 30 on the bonding layer 20. The bonding material supplying unit 20A forms the bonding layer 20 by, for example, printing. Examples of a printing method used by the bonding material supplying unit 20A include a letter pressing method, a flexographic method, and a gravure method.

The printing step is a step of forming the print layer 35 on the front surface of the upper base material sheet 30. The print layer 35 includes a display including, for example, characters and figures. As illustrated in FIG. 7 and FIG. 10, in the printing step, the print layer 35 is formed on the front surface of the upper base material sheet 30 by a printing unit 35A. Examples of the printing method used by the printing unit 35A include a letter pressing method, a flexographic method, and a gravure method. Note that when the upper base material sheet 30 has already been subjected to printing on at least one of the front surface and the back surface in a separate step, the printing step may be omitted.

The cutting step is a step of cutting the upper base material sheet 30 along the outer shapes of the plurality of upper base materials 32 to form the plurality of upper base materials 32 aligned at intervals in one direction. As illustrated in FIG. 7 and FIG. 11, in the cutting step, the upper base material sheet 30 is cut by the cutting unit 210 along the outer shape of each upper base material 32. The cutting unit 210 may have a blade shape having a shape conforming to the outer shape of the upper base material 32. In the cutting step in the present embodiment, the upper base material sheet 30 is cut from the front surface of the upper base material sheet 30 toward the lower base material sheet 10 such that the recessed portion 12a (see FIG. 12) conforming to the outer shape of each upper base material 32 is formed in the front surface of the lower base material sheet 10.

The removing step is a step of removing portions of the upper base material sheet 30 other than the plurality of upper base materials 32 from the lower base material sheet 10. In the removing step according to the present embodiment, as illustrated in FIG. 7 and FIG. 12, portions of the upper base material sheet 30 and the print layer 35 other than portions overlapping with the upper base materials 32 in a layered direction are peeled off. The portions peeled off are rolled up by a roller. After this step, as illustrated in FIG. 12, the recessed portions 12a are formed at the portions of the front surface of the lower base material sheet 10 around the upper base materials 32.

The coating step is a step of forming the overcoat layer 40 on the front surface of the lower base material sheet 10 and each of the front surfaces of the plurality of upper base materials 32 by supplying a coating material to the front surface of the lower base material sheet 10 and each of the front surfaces of the plurality of upper base materials 32. As illustrated in FIG. 7, in the coating step, the coating material is supplied to the front surface of the lower base material sheet 10 and each of the front surfaces of the plurality of upper base materials 32 by a coating material supplying unit 40A. As illustrated in FIG. 13, in the coating step, the coating material is supplied to the front surface of the lower base material sheet 10 and each of the front surfaces of the plurality of upper base materials 32 such that the lower base material covering portion 42 and the upper base material covering portion 44 are formed and a gap is formed between the lower base material covering portion 42 and each upper base material 32. In the present embodiment, in the coating step, the side surface covering portion 46 is also formed in addition to the lower base material covering portion 42 and the upper base material covering portion 44, and the coating material is supplied such that the gap is formed between the lower base material covering portion 42 and the side surface covering portion 46. Note that the gap refers to a space in the front surface of the lower base material sheet 10 between an end portion of the lower base material covering portion 42 and an edge portion of the upper base material 32. Thus, as long as the gap is formed, the lower end portion of the side surface covering portion 46 may be connected to the end portion of the lower base material covering portion 42. The coating material supplying unit 40A forms the overcoat layer 40 by printing, for example. In particular, in a printing method using a roll plate, the gap can be easily formed by utilizing the thickness of the upper base material 32.

The adhesive layer forming step is a step of supplying an adhesive material to the back surface of the lower base material sheet 10, thus forming the adhesive layer 50 on the back surface of the lower base material sheet 10. As illustrated in FIG. 7, in the adhesive layer forming step, an adhesive material is supplied to the back surface of the lower base material sheet 10 by an adhesive material supplying unit 50A. The adhesive material supplying unit 50A forms the adhesive layer 50 by printing, for example.

FIG. 15 is a partially enlarged view of the label bulk roll 1. As illustrated in FIG. 15, in a state where the continuous label body 2 is wound up into a roll shape such that the adhesive layer 50 is in contact with the overcoat layer 40 from above, the side surface covering portion 46 is interposed between the adhesive layer 50 and the upper base material 32. Thus, contact between the adhesive layer 50 and the upper base material 32 is suppressed.

As described above, in the manufacturing method of the label bulk roll 1 according to the present embodiment, the portions of the upper base material sheet 30 other than the plurality of upper base materials 32 are removed from the lower base material sheet 10 in the removing step, and subsequently the coating material is supplied in the coating step, which causes the gap to be formed between the lower base material covering portion 42 included in the overcoat layer 40 and each upper base material 32. This makes the outline of each upper base material 32. As a result, a label bulk roll in which each upper base material 32 serves as a display part having remarkable designability can be manufactured.

In addition, in the manufacturing method of the labeled article 5 in the above-described embodiment, the activated label 3A is conveyed to the separated position separated from the activation position, and the affixing step is performed at the separated position. Thus, it is possible to improve utility since the device (energy radiation unit 120) that activates the adhesive layer 50 is separated from the device that affixes the activated label 3A to the article. In other words, since the adhesive layer 50 of the label 3 has a relatively long open time after activation, in the affixing step of the manufacturing method of the labeled article 5, the activated label 3A can be affixed to the article B by a simple device such as a conventional tack labeler.

Additionally, in the label 3 of the above-described embodiment, the lower base material 12 and the adhesive layer 50 have optical transparency, and the haze value in the non-overlapping region A20 is less than 10.0. Thus, when the label 3 is affixed to the article B having optical transparency, the non-overlapping region A20 is substantially assimilated with the article B, and the overlapping region A10 including the upper base material 32 stands out and is visually recognized as a main design part.

In the above-described embodiment, as illustrated in FIG. 16, the bonding material supplying unit 20A may form, on the lower base material sheet 10, the bonding layer 20 including a central bonding portion 21 having an outer shape corresponding to the outer shape of the upper base material 32, and a peripheral bonding portion 22 formed around the central bonding portion 21. The peripheral bonding portion 22 has an outer shape larger than the outer shape of the upper base material 32 and has an adhesive force smaller than an adhesive force of the central bonding portion 21. The peripheral bonding portion 22 is formed by gradation printing, for example.

In this way, as illustrated in FIG. 17, even when the print layer 35 and the upper base material 32 are cut at a position slightly shifted from the normal cutting position of the upper base material 32 in the cutting step, peel-off of the edge portion of the upper base material 32 from the lower base material 12 is suppressed. Note that, in FIG. 17, the normal cutting position is indicated by a two-dot chain line.

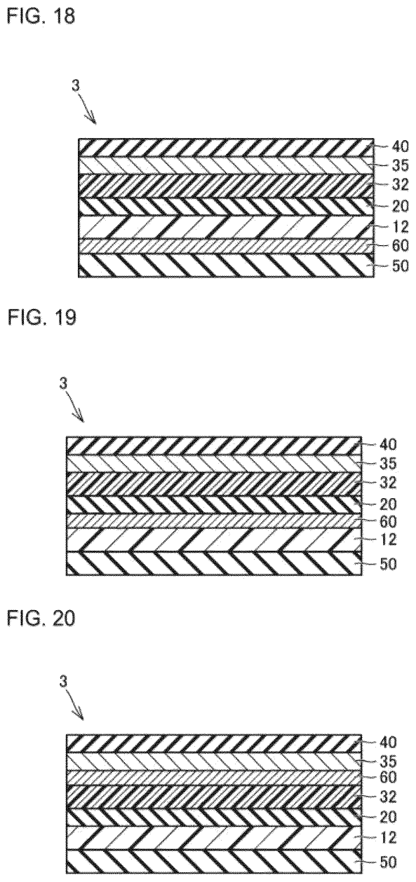

In the embodiment described above, as illustrated in FIG. 18 to FIG. 20, the label 3 may include an activation promoting layer 60. The activation promoting layer 60 is a layer that promotes activation of the adhesive layer 50 by absorbing light energy (e.g., ultraviolet light). The activation promoting layer 60 is made of, for example, a material containing resin and an energy absorber (e.g., an ultraviolet absorber). An addition amount of the energy absorber to the activation promoting layer 60 is preferably from 5% to 30%, and more preferably from 10% to 20%. The activation promoting layer 60 may be provided between the adhesive layer 50 and the lower base material 12 as illustrated in FIG. 18, may be provided between the lower base material 12 and the bonding layer 20 as illustrated in FIG. 19, or may be provided between the upper base material 32 and the print layer 35 as illustrated in FIG. 20.

In the label 3 including the activation promoting layer 60, an energy absorber is preferably added to the adhesive layer 50. An addition amount of the energy absorber to the adhesive layer 50 is preferably from 0.5% to 10%, and more preferably from 1% to 5%.

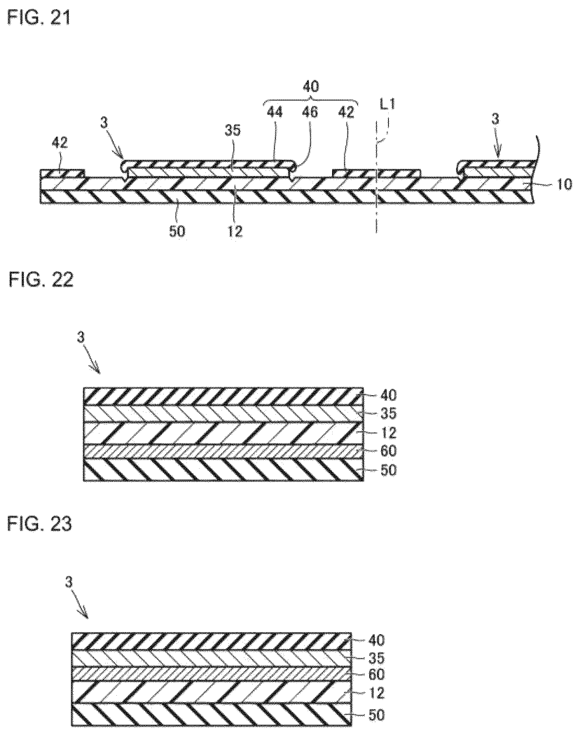

Further, in the above-described embodiment, as illustrated in FIG. 21, the upper base material 32 and the bonding layer 20 may be omitted from the label 3. That is, the label 3 may include only a single base material 12.

Further, when the label 3 includes only the single base material 12, the label 3 preferably includes the activation promoting layer 60, as illustrated in FIG. 22 and FIG. 23. The activation promoting layer 60 may be provided between the adhesive layer 50 and the base material 12 as illustrated in FIG. 22, or may be provided on the front surface of the base material 12, that is, between the base material 12 and the print layer 35 as illustrated in FIG. 23.

### Examples

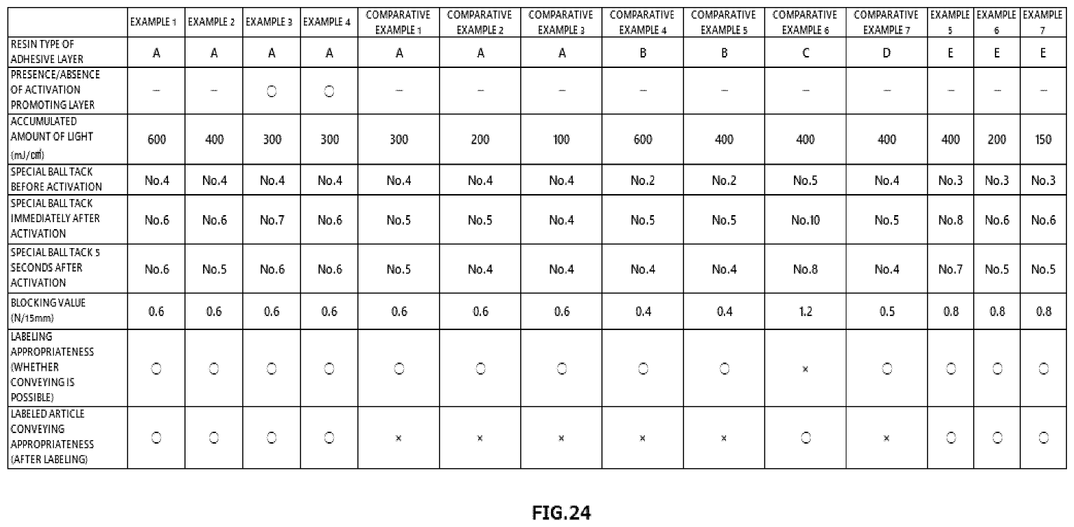

Next, Examples of the label 3 will be described together with Comparative Examples with reference to FIG. 24. Examples 1, 2, 5 to 7 and Comparative Examples 1 to 7 are examples of the label 3 illustrated in FIG. 21, Example 3 is an example of the label 3 illustrated in FIG. 22, and Example 4 is an example of the label 3 illustrated in FIG. 23. That is, only the labels 3 in Examples 3 and 4 include the activation promoting layer 60. In addition, in each of the Examples and Comparative Examples, an ultraviolet absorber is added to the adhesive layer 50.

In FIG. 24, labeling appropriateness (whether conveying is possible) means conveyability of the label 3 in the conveying step, and labeled article conveying appropriateness (after labeling) means the presence or absence of peel-off of the label 3 after the affixing step.

As shown in each comparative example in FIG. 24, the adhesive layer 50 containing resin whose type was A (Comparative Examples 1 to 3) had an insufficient affixing force immediately after activation and 5 seconds after the activation (ball number less than ball No. 6) when an accumulated amount of light in the activating step was equal to or less than 300, which caused peel-off of the label 3 because of a lack of adhesive force of the adhesive layer 50 after the affixing step. The adhesive layer 50 containing resin whose type was B (Comparative Examples 4 and 5) had an insufficient adhesive force after the affixing step when an accumulated amount of light in the activating step was equal to or less than 600, which caused peel-off of the label 3. The adhesive layer 50 containing resin whose type was D (Comparative Example 7) had an insufficient adhesive force after the affixing step when an accumulated amount of light in the activating step was 400, which caused peel-off of the label 3.

Further, the adhesive layer 50 containing resin whose type is C (Comparative Example 6) had a sufficient affixing force immediately after the activation and 5 seconds after the activation, but the affixing force before the activation was too large (ball number was ball No. 5, and blocking value was 1.2 N/15 mm, which is larger than 1.0 N/15 mm). Thus, the label 3 had poor conveyability in the conveying step and was not satisfactorily affixed.

On the other hand, in Examples 1 to 7, since the ball number was equal to or less than ball No. 4 before the activation of the adhesive layer 50, the conveyability of the label 3 in the conveying step was good. Further, since the ball number was equal to or more than ball No. 6 immediately after the activation of the adhesive layer 50 and 5 seconds after the activation, the adhesive force of the adhesive layer 50 after the affixing step was not insufficient, and the label 3 was not peeled off.

In addition, from Examples 3 and 4 and Comparative Example 1, it was confirmed that providing the activation promoting layer 60 improved both the labeling appropriateness and the labeled article conveying appropriateness without increasing the accumulated amount of light. Further, from comparison between Example 3 and Example 4, it was confirmed that the activation promoting layer 60 is more preferably provided between the base material 12 and the adhesive layer 50.

Note that when the same tests as described above were performed on the label 3 including the lower base material 12 and the upper base material 32, results similar to the results shown in FIG. 24 were obtained.

It will be appreciated by those skilled in the art that the exemplary embodiments described above are specific examples of the following aspects.

A manufacturing method of a labeled article according to the above-described embodiment includes a preparing step of preparing a label bulk roll formed by winding up a continuous label body being linerless into a roll shape, the continuous label body including a base material sheet having a shape extending in one direction and an adhesive layer provided on a back surface of the base material sheet, a feeding step of feeding the continuous label body from the label bulk roll, a cutting step of cutting the continuous label body into individual units of labels, an activating step of activating the adhesive layer of the label, a conveying step of conveying an activated label that is the label including the adhesive layer in an activated state from an activation position where the adhesive layer is activated to a separated position separated from the activation position, and an affixing step of affixing the activated label to an article at the separated position.

In the manufacturing method of the labeled article, the activated label is conveyed to the separated position separated from the activation position and the affixing step is performed at the separated position. Thus, it possible to improve utility since the device that activates the adhesive layer is separated from a device that affixes the activated label to an article.

In addition, it is preferable that an affixing force of the adhesive layer in the label bulk roll prepared in the preparing step is equal to or less than ball No. 4 in a special ball tack test before activation of the adhesive layer, is equal to or more than ball No. 6 in the special ball tack test immediately after the activation of the adhesive layer, and is equal to or more than ball No. 5 in the special ball tack test 5 seconds after the activation of the adhesive layer.

In this aspect, the affixing force of the adhesive layer is equal to or less than ball No. 4 in the special ball tack test before the activation of the adhesive layer, which helps prevent the occurrence of blocking when the continuous label body is fed out from the label bulk roll. Further, the affixing force is equal to or more than ball No. 5 in the special ball tack test 5 seconds after the activation of the adhesive layer, which effectively secures the affixing force of the label to the article in the affixing after the conveying step.

Further, it is preferable that the continuous label body in the label bulk roll prepared in the preparing step further includes a plurality of upper base materials provided on a front surface of the base material sheet, the plurality of upper base materials being aligned at intervals in the one direction, and an overcoat layer provided on the front surface of the base material sheet and a front surface of each upper base material of the plurality of upper base materials, and a blocking value when the continuous label body is fed out from the label bulk roll in the feeding be equal to or less than 1.0 N/15 mm.

This configuration suppresses the occurrence of blocking when the continuous label body is fed out from the label bulk roll.

In addition, it is preferable that each of the labels in the label bulk roll prepared in the preparing step includes an energy absorber that absorbs light energy, and in the activating step, the adhesive layer is preferably activated by the label being irradiated with the light energy.

This configuration effectively activates the adhesive layer in the activating step. In this case, it is preferable that each of the labels in the label bulk roll prepared in the preparing step further includes an activation promoting layer including the energy absorber, the activation promoting layer being configured to absorb the light energy and thus promote the activation of the adhesive layer.

The activation promoting layer is more preferably provided on a front surface of the base material sheet or between the base material sheet and the adhesive layer.

Further, a label bulk roll according to the embodiment described above is formed by winding up a continuous label body being linerless into a roll shape, the continuous label body includes a base material sheet having a shape extending in one direction, and an adhesive layer provided on a back surface of the base material sheet, and an affixing force of the adhesive layer is equal to or less than ball No. 4 in a special ball tack test before activation of the adhesive layer, is equal to or more than ball No. 6 in the special ball tack test immediately after the activation of the adhesive layer, and is equal to or more than ball No. 5 in the special ball tack test 5 seconds after the activation of the adhesive layer.

In this case, it is preferable that the continuous label body further includes an overcoat layer provided on a front surface of the base material sheet and on a front surface of each upper base material of the plurality of upper base materials, and a blocking value when the continuous label body is fed out from the label bulk roll is equal to or less than 1.0 N/15 mm.

In addition, it is preferable that the continuous label body further includes an activation promoting layer including a light energy absorber, the activation promoting layer being configured to absorb the light energy and thus promote activation of the adhesive layer, and the adhesive layer is made of a material that is activated due to irradiation with the light energy.

In addition, a label according to the embodiment includes a lower base material, an adhesive layer provided on a back surface of the lower base material, and an upper base material provided on a front surface of the lower base material, the upper base material having an outer shape smaller than an outer shape of the lower base material, and an affixing force of the adhesive layer is equal to or less than ball No. 4 in a special ball tack test before activation of the adhesive layer, is equal to or more than ball No. 6 in the special ball tack test immediately after the activation of the adhesive layer, and is equal to or more than ball No. 5 in the special ball tack test 5 seconds after the activation of the adhesive layer.

Note that all matters described in the embodiments and examples described above is to be understood as being exemplary, and no limitation is intended. The scope of the present invention is defined by the claims and not the embodiments and examples described above, and meanings equivalent to those in the claims and all modifications made within the claims are also included.

### REFERENCE SIGNS LIST

1 Label bulk roll, 2 Continuous label body, 3 Label, 5 Labeled article, 10 Lower base material sheet, 12 Lower base material, 12a Recessed portion, 20 Bonding layer, 20A Bonding material supplying unit, 21 Central bonding portion, 22 Peripheral bonding portion, 30 Upper base material sheet, 32 Upper base material, 35 Print layer, 35A Printing unit, 40 Overcoat layer, 40A Coating material supplying unit, 42 Lower base material covering portion, 44 Upper base material covering portion, 46 Side surface covering portion, 50 Adhesive layer, 50A Adhesive material supplying unit, 110 Cutting unit, 120 Energy radiation unit, 130 Conveying unit, 210 Cutting unit, 300 Ball rolling device, 310 Inclined surface, 320 Sample, 330 Ball, A10 Overlapping region, A20 Non-overlapping region, A21 Outer region, A22 Inner region, B Article.

1. A manufacturing method of a labeled article, the manufacturing method comprising:
a preparing step of preparing a label bulk roll formed by winding up a continuous label body being linerless into a roll shape, the continuous label body including a base material sheet having a shape extending in one direction and an adhesive layer provided on a back surface of the base material sheet;
a feeding step of feeding the continuous label body from the label bulk roll;
a cutting step of cutting the continuous label body into individual units of labels;
an activating step of activating the adhesive layer of the label;
a conveying step of conveying an activated label that is the label including the adhesive layer in an activated state from an activation position where the adhesive layer is activated to a separated position separated from the activation position; and
an affixing step of affixing the activated label to an article at the separated position.

2. The manufacturing method of the labeled article according to claim 1, wherein
an affixing force of the adhesive layer in the label bulk roll prepared in the preparing step is equal to or less than ball No. 4 in a special ball tack test before activation of the adhesive layer, is equal to or more than ball No. 6 in the special ball tack test immediately after the activation of the adhesive layer, and is equal to or more than ball No. 5 in the special ball tack test 5 seconds after the activation of the adhesive layer.

3. The manufacturing method of the labeled article according to claim 1, wherein
the continuous label body in the label bulk roll prepared in the preparing step further includes
a plurality of upper base materials provided on a front surface of the base material sheet, the plurality of upper base materials being aligned at intervals in the one direction, and
an overcoat layer provided on the front surface of the base material sheet and a front surface of each upper base material of the plurality of upper base materials, and
a blocking value when the continuous label body is fed out from the label bulk roll in the feeding step is equal to or less than 1.0 N/15 mm.

4. The manufacturing method of the labeled article according to claim 1, wherein
each of the labels in the label bulk roll prepared in the preparing step includes an energy absorber that absorbs light energy, and
in the activating step, the adhesive layer is activated by the label being irradiated with the light energy.

5. The manufacturing method of the labeled article according to claim 4, wherein
each of the labels in the label bulk roll prepared in the preparing step further includes an activation promoting layer including the energy absorber, the activation promoting layer being configured to absorb the light energy and thus promote the activation of the adhesive layer.

6. The manufacturing method of the labeled article according to claim 5, wherein
the activation promoting layer is provided on a front surface of the base material sheet or between the base material sheet and the adhesive layer.

7. A label bulk roll formed by winding up a continuous label body being linerless into a roll shape, wherein
the continuous label body includes
a base material sheet having a shape extending in one direction, and
an adhesive layer provided on a back surface of the base material sheet, and
an affixing force of the adhesive layer is equal to or less than ball No. 4 in a special ball tack test before activation of the adhesive layer, is equal to or more than ball No. 6 in the special ball tack test immediately after the activation of the adhesive layer, and is equal to or more than ball No. 5 in the special ball tack test 5 seconds after the activation of the adhesive layer.

8. The label bulk roll according to claim 7, wherein
the continuous label body further includes
a plurality of upper base materials provided on a front surface of the base material sheet, the plurality of upper base materials being aligned at intervals in the one direction, and
an overcoat layer provided on the front surface of the base material sheet and on a front surface of each upper base material of the plurality of upper base materials, and
a blocking value when the continuous label body is fed out from the label bulk roll is equal to or less than 1.0 N/15 mm.

9. The label bulk roll according to claim 7, wherein
the continuous label body further includes an activation promoting layer including a light energy absorber, the activation promoting layer being configured to absorb the light energy and thus promote activation of the adhesive layer, and
the adhesive layer is made of a material that is activated due to irradiation with the light energy.

10. A label comprising:
a lower base material;
an adhesive layer provided on a back surface of the lower base material; and
an upper base material provided on a front surface of the lower base material, the upper base material having an outer shape smaller than an outer shape of the lower base material, wherein
an affixing force of the adhesive layer is equal to or less than ball No. 4 in a special ball tack test before activation of the adhesive layer, is equal to or more than ball No. 6 in the special ball tack test immediately after the activation of the adhesive layer, and is equal to or more than ball No. 5 in the special ball tack test 5 seconds after the activation of the adhesive layer.
